(19) United States
(12) Patent Application Publication
(10) Pub. No.: US 2012/0096984 A1
(43) Pub. Date: Apr. 26, 2012

(54) Flywheel System

(76) Inventor: Bill Gray, San Francisco, CA (US)

(21) Appl. No.: 13/381,093

(22) PCT Filed: Jul. 6, 2010
(86) PCT No.: PCT/US10/41098

§ 371 Date: Dec. 29, 2011

Related U.S. Application Data
(60) Provisional application No. 61/223,855, filed on Jul. 8, 2009.

(51) Int. Cl. F16F 15/30; H02K 7/02

(52) U.S. Cl. 74/572.12; 74/572.1

(57) ABSTRACT

A flywheel system has damped gimbal system suspending a motor generator which is in turn linked by means of any number of flexible couplings and rigid shafts to a flywheel rotor system so as to provide safe passive stability to the highly energized spinning rotor system and high torque transmitting capacity.

### BACKGROUND

It is highly desirable to be able to store electrical energy for later use.

There are many technologies that are able to store and regenerate electrical energy, but few of these methods are able to do so cheaply enough to be economically useful in applications that are connected to large scale system such as utilities' electricity grids. All the few currently available technologies that are able to perform economically are limited in their usefulness by various geographical, geological, and/or topological requirements that limit their ultimate achievable capacity, and their proximity to potential users.

The inexpensive storage of large quantities of electrical power can allow generators, transmitters, distributors, and users of electricity to smooth large swings in their power requirements allowing for significant increases in fuel and capital efficiency. Beyond this purely economical value of inexpensive electricity storage, a very large environmental value has become apparent. CO₂ produced by fossil-fuel-based electricity generation is a major contributor to the problem of global warming. While their are numerous generation technologies in the market place that can produce large quantities of usable electricity without producing CO₂ and other pollutants as a byproduct, none of the currently known and readily expandable solutions is able to arbitrarily increase or decrease its output to match user demand. Technologies based on wind, solar, and tidal energy conversion are only able to generate electricity when these energy sources are available. Nuclear power is notoriously hard to rapidly increase and decrease, running far more efficiently when operated at a steady-state output. Because of these temporal limitations, these technologies are only able to serve a small portion of total electricity demand, and must rely on fossil-fuel generation to provide power at critical times. In order for these technologies to economically grow as a percentage of total system generation capacity they require very large increases in the capacity to store and regenerate electricity.

Much attention has been given in recent years to the notion of using a flywheel for such storage. The goal is to use electrical energy via a motor to accelerate a flywheel thereby converting the electrical energy into kinetic energy stored in the momentum of the flywheel. Once the electrical energy has been converted into kinetic energy one can optionally to permit time to pass during which the flywheel spins freely. Later, energy can be drawn down from the system by allowing the momentum of the flywheel to drive a generator or alternator. This slows the flywheel and converts its' stored kinetic energy back into electrical energy.

The energy storage flywheel is a very old idea that has been in widespread use for a long time. The electricity storage flywheel or electro-mechanical battery, like the one described above is also not a new idea and some flywheel based systems have been proven to be able to provide some high value services to grid connected applications such as frequency regulation and short term emergency power backup. Excepting the invention disclosed in this document, no flywheel energy storage system that the inventor is presently aware of is able to provide storage economically enough to be of widespread utility as a bulk energy storage solution.

The economic viability of a flywheel system is a function of many factors. Of these, the most important are capital costs of construction, conversion efficiency of the “spin up” and “draw down” processes, and the coasting efficiency or how much energy is lost while the flywheel is in a charged state but power is neither being applied to or drawn from it.

The kinetic energy stored in the flywheel is ½Iω² where I is the moment of inertia of the flywheel and ω is the angular velocity of the flywheel. In order to maximize this equation per unit cost, it is generally desirable to form the flywheel rotor material into a shape that maximize the moment of inertia for a given amount of material. One of the most efficient flywheel rotor shapes then is a ring or hoop of material.

There are a multitude of design issues that must be considered in the construction of a flywheel. Those include, but are not limited to material cost, fabrication cost, dynamic stability, internal friction, bearing technique and arrangement, motor/generator technique and arrangement, and enclosure.

One class of flywheel rotors, generally known as “bare filament rotors” have numerous advantages where low cost flywheel rotors are required. Bare filament rotors are rotors where the primary tensile portion of the flywheel rotor is made up of filaments (fibers, cords, cables, ropes, strings, or lines) that are, in the majority, not bonded together in a rigid matrix. Bare filament rotors do not suffer from, or are far less prone to, many of the rotordynamic issues that limit the cost performance of typical rigid flywheel rotors constructed of either isotropic materials or composites of filaments that bonded in a rigid matrix. In some known designs, the filaments of the rotor are bonded in a flexible matrix or rubber like material. Depending on the flexibility of the matrix material, these systems either behave more or less like rigid system or more or less like bare filament systems. For the purposes of this document, if the bonding matrix is flexible enough to allow the individual filaments to move with respect to each other to a degree that the rotor behaves ostensibly like a bare filament system, it will be considered under the name “bare filament” rotor even though the filaments are not technically bare.

Despite the simplicity and economy of bare filament rotor systems, their use in operational applications outside the laboratory and academic settings is extremely rare. This is in large part because the very properties that make the bare filament rotor so attractive also lead it to be very difficult to balance accurately. As any rotor system accelerates to higher and lower rotational speeds the materials that make up that rotor system experience changing stresses which in turn result in changing deformations and changing center of mass. Because the filaments of a bare filament rotor are able to move with respect to one and other fairly freely, the resultant changes in center of mass can be large. These changes in the center of mass of the rotor also change it's preferred axis of rotation. If the actual axis or rotation of a rotor system is different from its preferred axis of rotation instability of the rotor system results. The greater the difference between actual and preferred axis, the greater the instability.

Instability in flywheel rotor systems is at best a source of wear and efficiency loss. At worst instability is a source of potentially destructive forces to the flywheel bearing system or housing. Instability in all flywheel rotor systems is best minimized. Because the bare filament rotor if more prone to change its preferred axis of rotation and is their for subject to greater and less predicable instabilities, its use in real world applications is limited.

This document describes a number of methods and apparatus for passively stabilizing any flywheel rotor system in a way that allows the rotor find its way to an axis of rotation that is very close to or identical to it's preferred axis of rotation. These methods and apparatus are able to passively adjust themselves so that changes in the center of mass or preferred axis of rotation that would other wise cause instability can be readily accommodated. These methods and apparatus are applicable to all rotor systems, rigid and other wise, but the are especially useful for bare filament rotor systems as they enable bare filament rotors to operate reliably through wide velocity ranges in a highly stable manor.

### DESCRIPTION OF THE DRAWING

The invention will be described with respect to a drawing in several figures.

FIG. 1 shows the current standard quill shaft technique for self balancing rotors

FIG. 2 shows the displacement issue that occurs not infrequently when using the quill shaft technique.

FIG. 3 is a motor/generator housed standard axially symmetric gimbal system.

FIG. 4 is a motor/generator housed in a 2 axis non-symmetric gimbal

FIG. 5 is a complete passively self stabilizing non-symmetric gimbal system with standard sub-circular bare filament flywheel rotor utilizing a single flexibly jointed in an other wise rigid shaft.

FIG. 6 is a complete passively self stabilizing non-symmetric gimbal system with super-circular bare filament flywheel rotor utilizing a single flexible joint in an other wise rigid shaft.

FIG. 7 is a symmetric gimbal system with super-circular bare filament flywheel rotor utilizing a single flexible joint in an other wise rigid shaft.

FIG. 8 is a non-symmetric gimbaled system with sub-circular bare filament flywheel rotor utilizing a single two flexible joints in an other wise rigid shaft.

FIG. 9 is is a non-symmetric gimbaled system with sub-circular bare filament flywheel rotor utilizing a single three flexible joints in an other wise rigid shaft.

FIG. 10 is a non-symmetric gimbaled system with sub-circular bare filament flywheel rotor utilizing a single three flexible joints in an other wise rigid shaft demonstrating that the whirl condition that is is a major disadvantage of the quill shaft system becomes possible with a jointed rigid shaft at the point where there are at least 3 joints.

FIG. 11. is a is a non-symmetric gimbaled system with sub-circular bare filament flywheel rotor utilizing a multitude of flexible joints in an other wise rigid shaft approximating a flexible shaft, but with higher torque carrying capability.

FIGS. 12-13 are standard sub-circular bare filament flywheel rotors.

FIGS. 14-15 are super-circular bare filament flywheel rotors.

FIG. 16 is a sub-circular bare filament flywheel rotor where the hoop of fibers take on a more cylindrical form.

FIG. 17 is a section view of the apparatus in FIG. 16.

FIG. 18 is a sub-circular bare filament flywheel rotor where the hoop of fibers take on a more cylindrical form.

FIG. 19 is a section view of the apparatus in FIG. 18.

FIG. 20 is a sub-circular bare filament flywheel rotor where the hoop of fibers take on a more cylindrical form where the stringers converge on the hub and the main hoop is held in its cylindrical shape by the use of rigid members.

FIG. 21 is a section view of the apparatus in FIG. 20.

### DETAILED DESCRIPTION

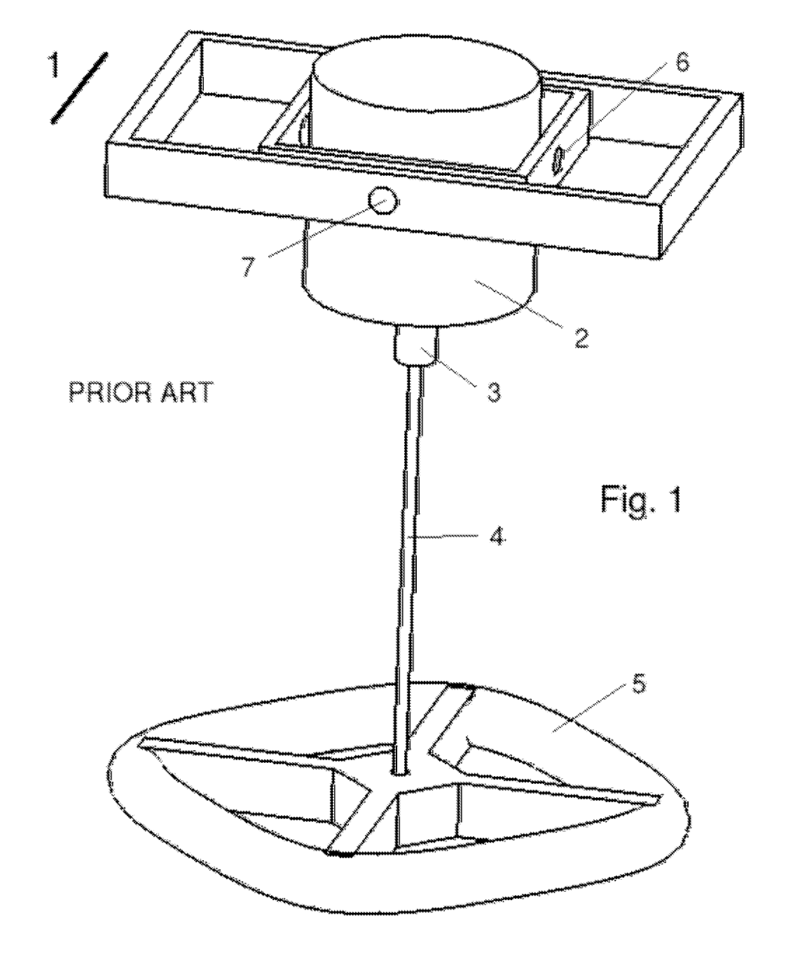

FIGS. 1 & 2 are perspective views of prior art sub-circular bare filament flywheel systems 1. Motor/generator 2 is suspended from a symmetric gimbal system which consists of gimbal axis 6 and 7 which are arranged perpendicularly to each other, but share the same approximately horizontal plane. The motor/generator's 2 shaft is coupled to a flexible quill shaft 4 by a standard rigid coupling 3. The flywheel rotor itself is of a typical sub circular bare filament rotor design.

This system is reported in D. W. Rabenhorst, T. R. Small, and W. O. Wilkinson “Low-Cost Flywheel Demonstration Program” The Johns Hopkins University Applied Physics Laboratory—Report Number DOE/EC/1-5085 April 1980.

This system 1 is also widely used for the balancing of flywheel rotor of virtually any type size and configuration.

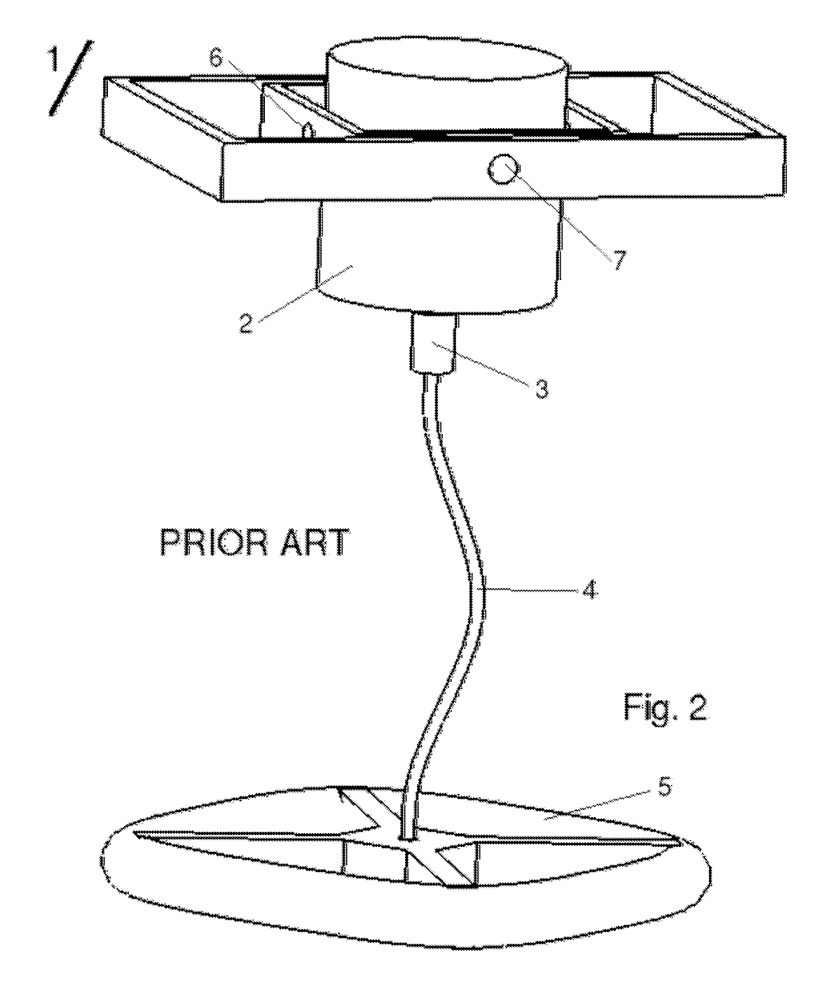

FIG. 2 shows one of the major limitations of this quill shaft system 1. The quill shaft 4 is a flexible shaft made either by using a very small diameter steel shaft of by using a larger diameter shaft of more flexible material such as fiber glass. When operating at high speed, the quill shaft 4 can to bow outward slightly as a result of slight imperfections in the shaft 4 or as a result of a disturbance to the system 1, or in reaction to excessive torque placed on the quill shaft 4 by the motor/generator 2. Once bowed slightly, the centripetal forces caused by rotation reenforce this bend, exacerbating it. This condition is not preferred as it leads to excessive loading of the bearing system housed in the motor/generator 2, and can also lead to the destruction of the quill shaft 4 and thus a catastrophic loss of control of the flywheel rotor 5.

Additionally, this quill shaft system 1 is not preferred because of the limited amount of torque that can be reasonably applied to the system. More torque can be transmitted only by a stouter shaft which in turn does not yield the required flexibility and stabilizing property. This torque limitation places a low upper limit on the amount of power that can be transmitted from the motor/generator 2 to the flywheel rotor 5, dramatically limiting the key power performance capability of the system 1.

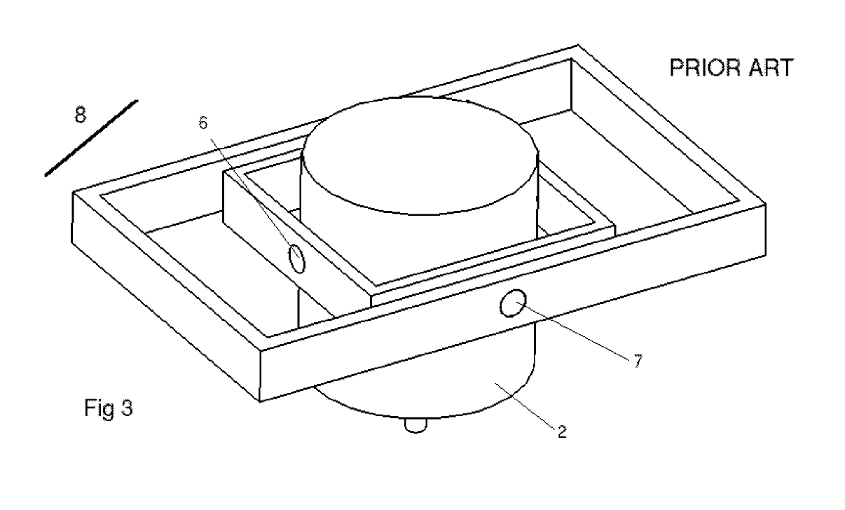

FIG. 3 shows an axially symmetric gimbal system 8 for the gimbaled suspension of motor/generator 2. axis 6 and 7 are on the same plane. Such systems 8 can incorporate an arbitrary number of axes beyond two, though axes beyond two are of limited utility.

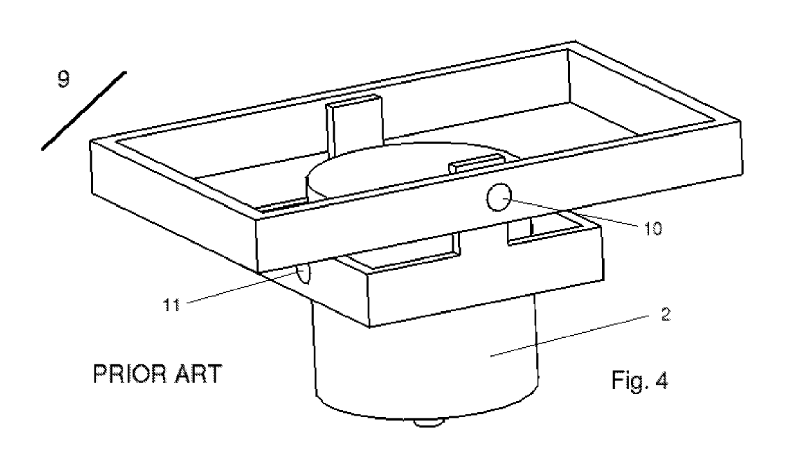

FIG. 4 shows a non-symmetric two axis gimbal system 9 for the suspension of a motor/generator 2 where the two axes 11 and 10 are on different planes. This system 9 can incorporate a arbitrary number of axes from one to infinity, but one axis does not provide as much freedom of movement as two axes, and three axes does not provide significant additional utility. Each axis 10 and 11 of this system are damped either through the use of a external damping system (not shown) or by the use of low efficiency bearings. Low efficiency bearings can be made by filling a standard ball bearing with high viscosity grease. Current test systems make successful use of both techniques.

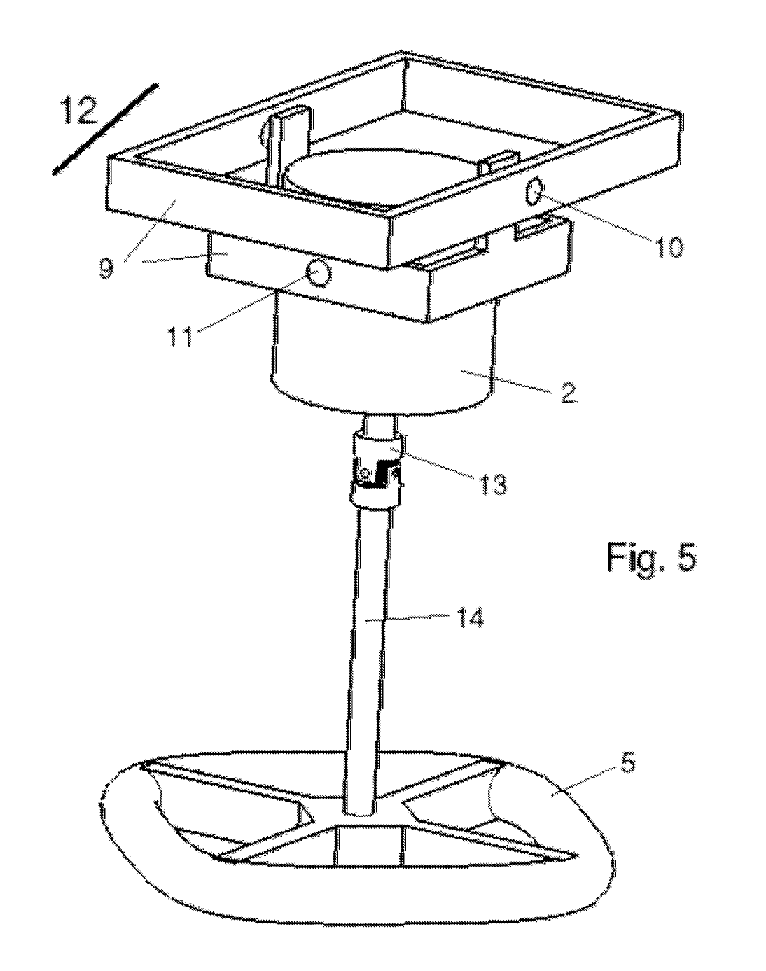

FIG. 5 shows an embodiment of the invention where in the non-symmetric damped gimbal system 9 is used. The shaft of motor/generator 2 is attached to a flexible coupling 13 which is also attached to a rigid shaft 14 which on its other end is rigidly attached to a sub-circular bare filament flywheel rotor 5. The shaft 14 can be made as shout as desired to transmit high levels of torque and will not suffer from destabilizing displacement described shown in FIG. 2.

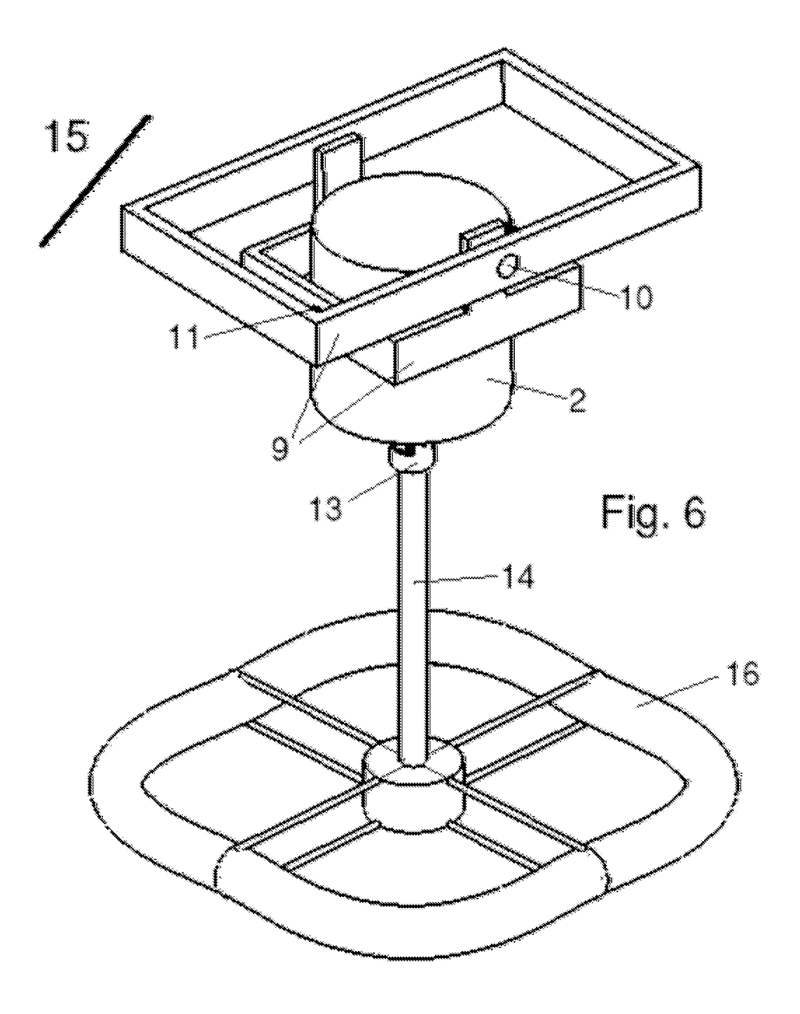

FIG. 6 shows an embodiment of the invention where in the non-symmetric damped gimbal system 9 is used. The shaft of motor/generator 2 is attached to a flexible coupling 13 which is also attached to a rigid shaft 14 which on its other end is rigidly attached to a super-circular bare filament flywheel rotor 16. The shaft 14 can be made as shout as desired to transmit high levels of torque and will not suffer from destabilizing displacement described shown in FIG. 2.

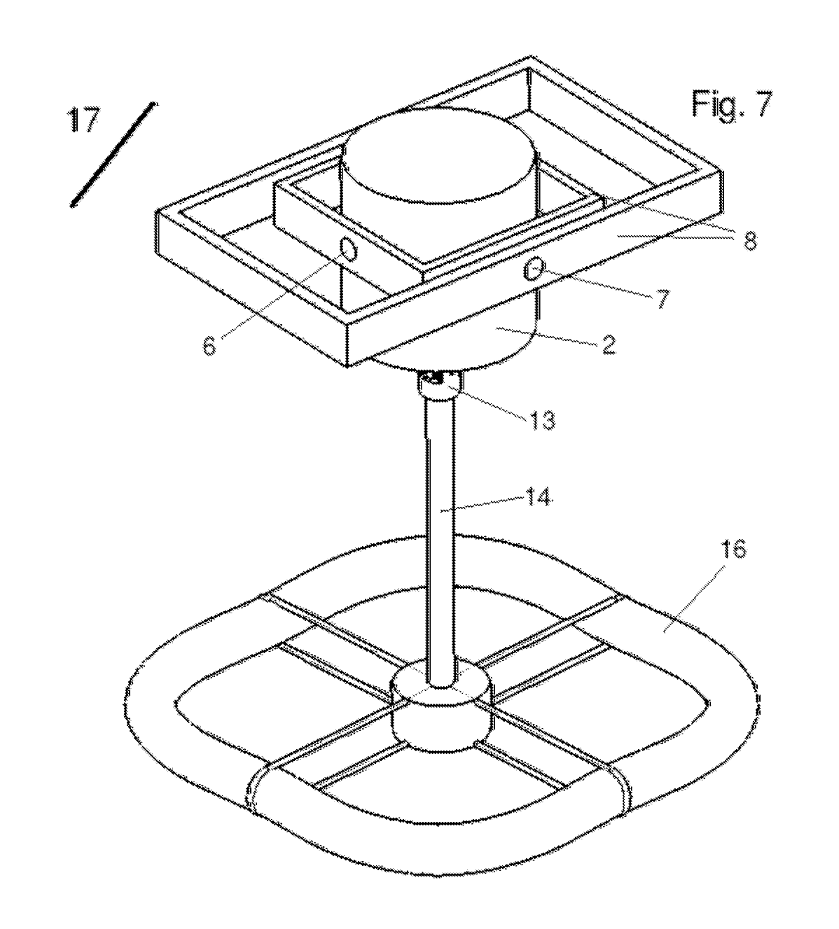

FIG. 7 shows an embodiment of the invention 17 where in the symmetric gimbal system 8 is used. The shaft of motor/generator 2 is attached to a flexible coupling 13 which is also attached to a rigid shaft 14 which on its other end is rigidly attached to a super-circular bare filament flywheel rotor 16. The shaft 14 can be made as shout as desired to transmit high levels of torque and will not suffer from destabilizing displacement described shown in FIG. 2. This embodiment is not preferred to system 15 because the non-symmetric damped gimbal system 9 of embodiment 15 has two different resonant base frequencies established by the differing lengths of the pendulum that each axis 10 and 11 create. This allows one axis 10 or 11 of the non-symmetric gimbal 9 to damp the resonant frequencies in the other axis 10 or 11. The symmetric gimbal system 8 does not have this feature because axes 6 and 7 are both on the same plane and establish approximately the same resonant frequency in the pendulum. Use of the symmetric gimbal 8 is not generally preferred, but it can be made adequate to the task of stabilization and allows the incorporation of a rigid shaft 14 with single flexible coupling 13 as opposed to the quill shaft 4.

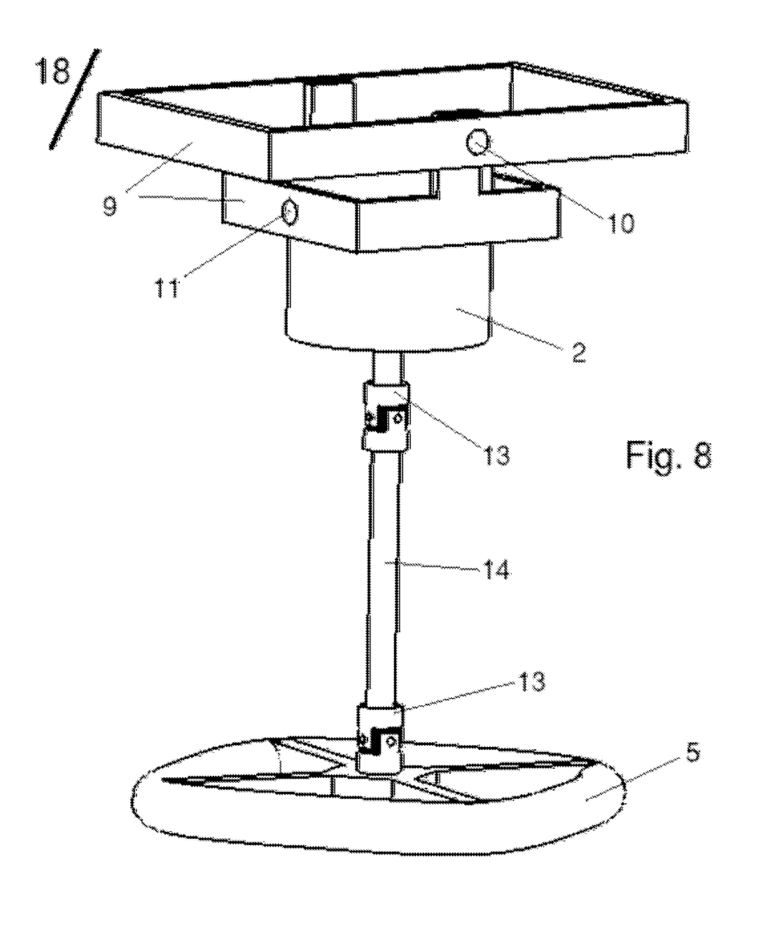

FIG. 8 shows an embodiment of the invention 18 where in the non-symmetric gimbal system 9 is used. The shaft of motor/generator 2 is attached to a flexible coupling 13 which is also attached to a rigid shaft 14 which on its other end is attached to second flexible coupling 13 which is attached to a sub-circular bare filament flywheel rotor 5. The shaft 14 can be made as shout as desired to transmit high levels of torque and will not suffer from destabilizing displacement described shown in FIG. 2. This embodiment is provides excellent stabilization and slightly better alignment of the flywheel rotor's 5 preferred axis of rotation with the actual axis of rotation yielding slightly lower bearing loading and thus slightly higher bearing efficiency and slightly lower wear. It is unclear whether these slight improvements make this system 18 preferable in to system 12 as the added flexible coupling 13 adds expense and complexity to the system.

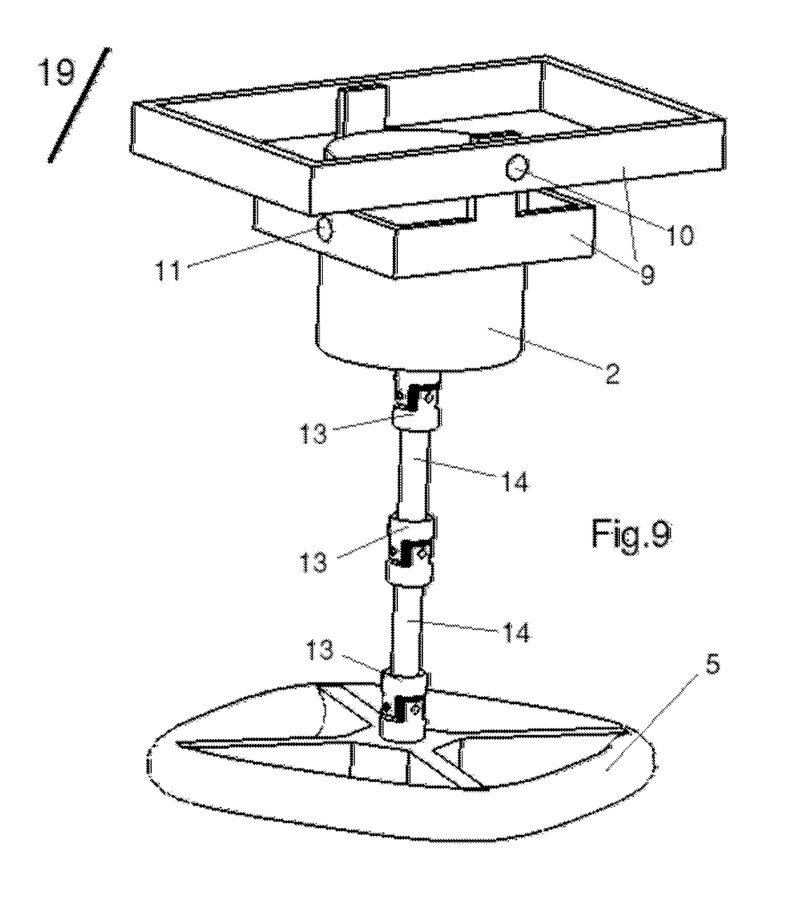

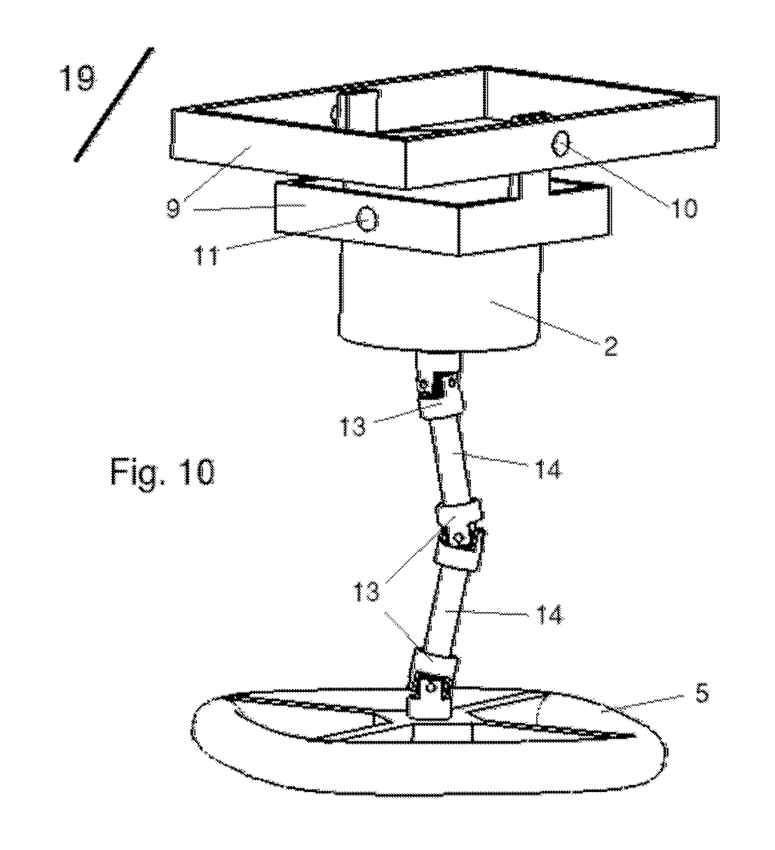

FIGS. 9 and 10 show an embodiment of the invention 19 where in the non-symmetric gimbal system 9 is used. The shaft of motor/generator 2 is attached to a flexible coupling 13 which is also attached to a rigid shaft 14 which on its other end is attached to second flexible coupling 13 which is in turn attached to a second rigid shaft 14, which is in turn attached to a third flexible coupling 13 which is attached to a sub-circular bare filament flywheel rotor 5. While this embodiment allows for the incorporation of shout rigid shaft, it is also susceptible to a similar displacement issue to the quill shaft as shown in FIG. 10.

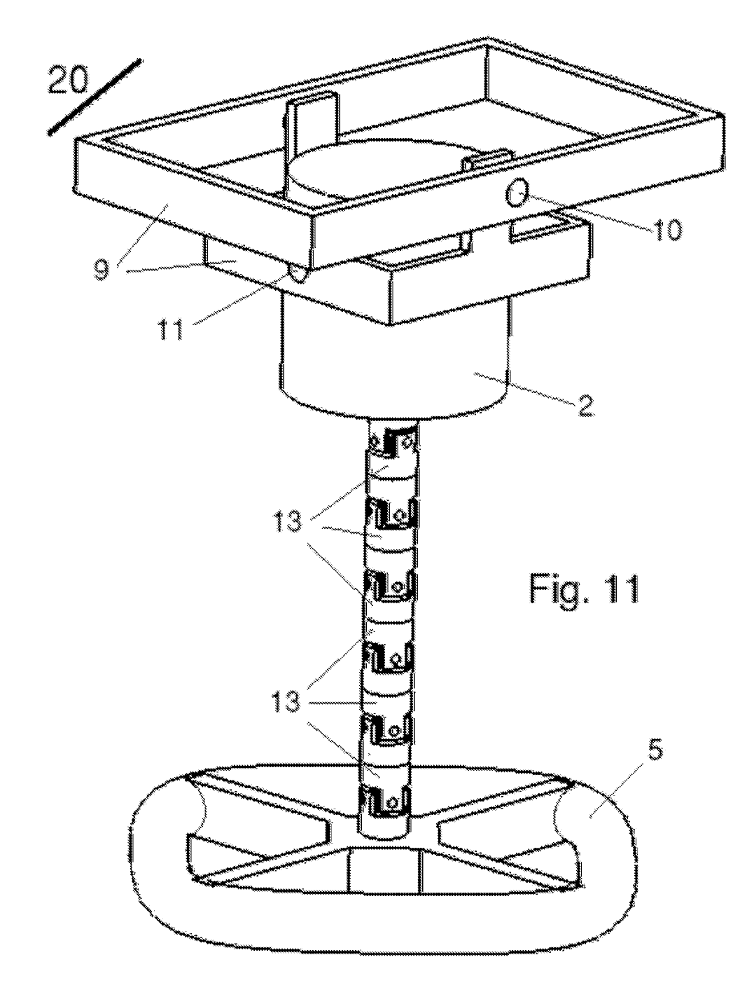

FIG. 11 shows and embodiment of the invention 20 where in the non-symmetric gimbal system 9 is used and an arbitrary number of flexible couplings 13 are used to connect the shaft of the motor/generator 2 with the flywheel rotor 5. This embodiment 20 achieves torque transmission better than a comparable quill shaft 4, but is subject to the same displacement issue as system 1 and 19. never the less, this embodiment constitutes an improvement on prior art. The flexible couplings 13 can be attached to one another directly, or with the use of a rigid shaft 14 (not visible).

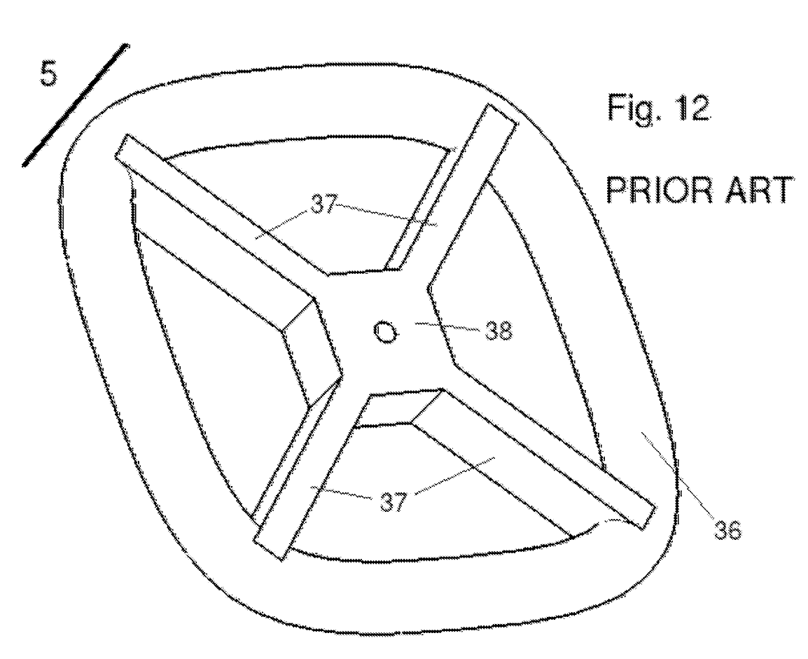

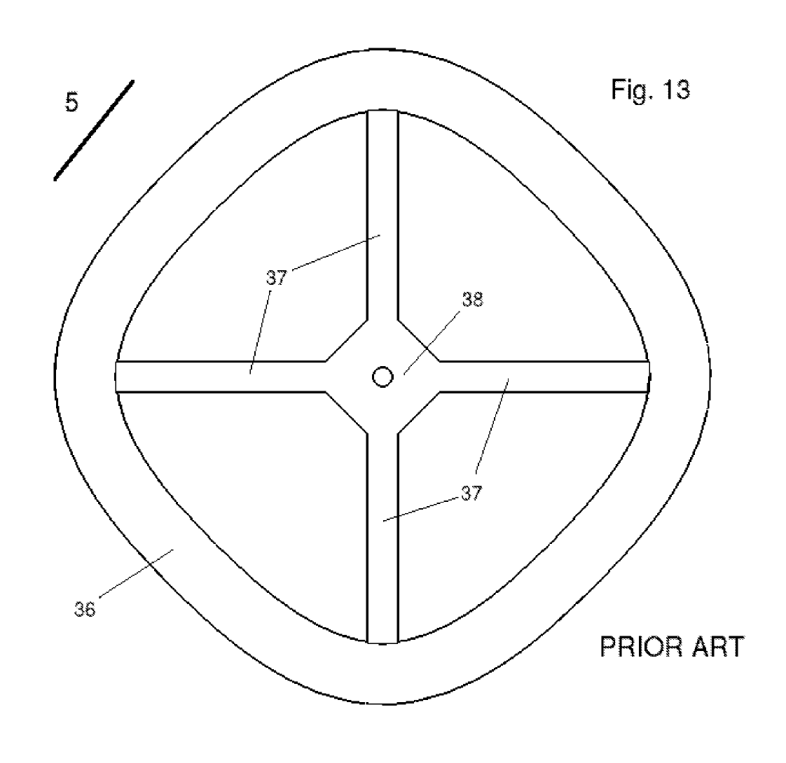

FIGS. 12 and 13 show a typical embodiment of the sub-circular bare filament flywheel rotor as described in G. Genta “Kinetic Energy Storage: Theory and Practice of Advanced Flywheel Systems” Butterworth-Hienemann Ltd. (February 1985) and in D. W. Rabenhorst, T. R. Small, and W. O. Wilkinson “Low-Cost Flywheel Demonstration Program” The Johns Hopkins University Applied Physics Laboratory—Report Number DOE/EC/1-5085 April 1980. The main hoop 36 is made up of flexible fibers, cords, or lines which are able to move with respect to one another to some degree and are arranged in an approximately toroidal shape which is to say that the vertical and horizontal cross section of the hoop 36 are approximately equal. The hoop 36 is bound to the hub 38 by rigid members 37. The hoop 36 defines an interior diameter that is smaller than the outer diameter defined by the rigid members 37. When spun about the hub 38 axis centripetal forces work on the hoop 36 to establish a more or less perfectly circular form. Because the rigid members 37 define a radius larger than the hoop's 36 ideal circle, the hoop 36 creates a compressive pressure on the rigid members 37 and the hoop is forced to assume a shape that is referred to as “sub circular”. This sub circular arrangement allows the flexible hoop 36 to be tightly linked with the hub 38 while while spinning still allowing the fibers in hoop 36 to remain largely independent of on another.

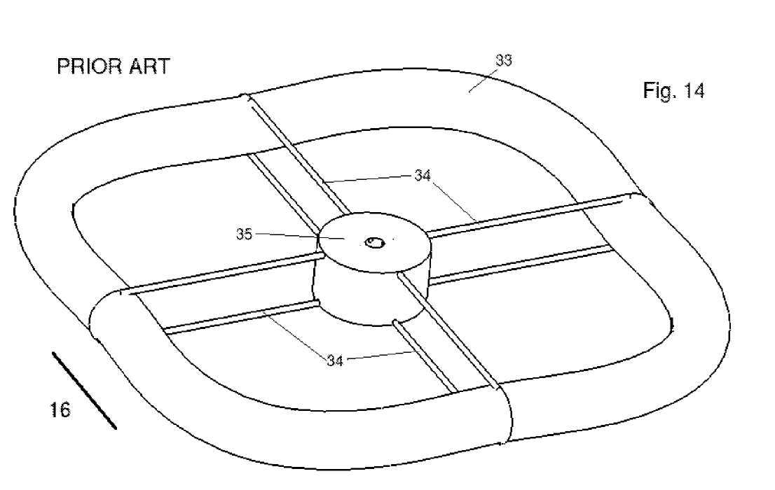

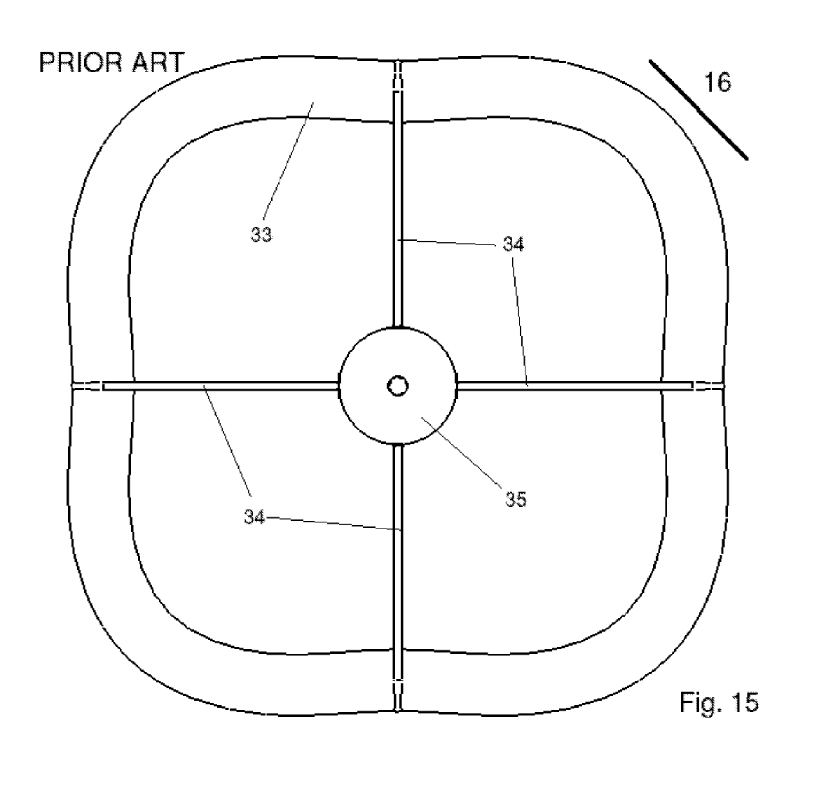

FIGS. 14 and 15 show a super-circular flywheel rotor 16 as described in the patent filed on Jan. 8, 2009 by Velkess. The super-circular flywheel 16 consists of a hoop 33 of tensile fibers, filaments, cords, or lines that form an approximately toroidal form which is to say that the vertical and horizontal cross section of the hoop 33 are approximately equal. The hoop 33 is held to a hub 35 by tensile stringers 34 that define a radius slightly smaller than the hoop 33. Because these stringers define a radius that is smaller than the hoop's 33 ideal circle, when the system 16 is spun about the axis of the hub 35, the hoop exerts a tensile force on the stingers as it tries to assume its ideal circle. The stringers 34 do not allow the hoop 33 to assume this ideal circle, but rather force it to assume a “super-circular” form. In this way, when spun, the hoop becomes linked with the hub 35 while still allowing the filaments of the hoop to remain largely independent of on another.

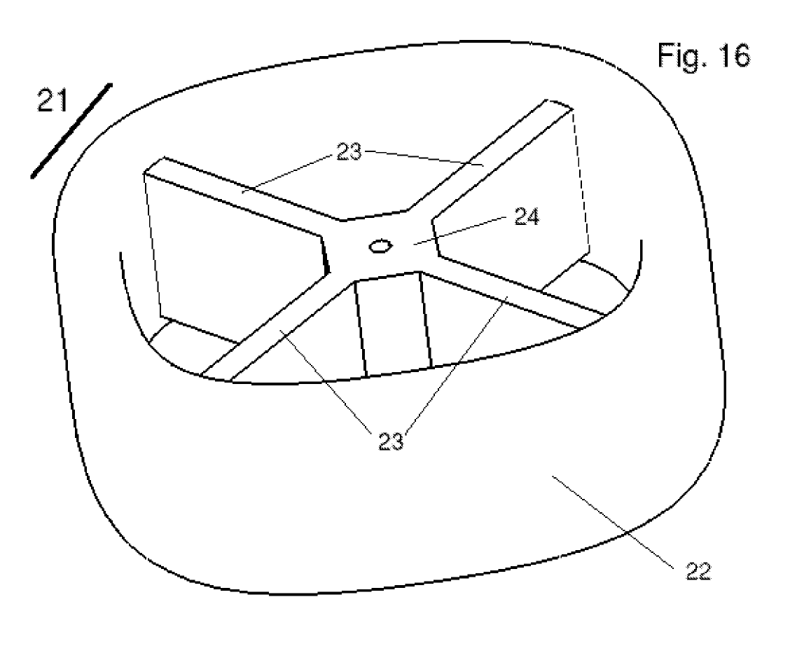

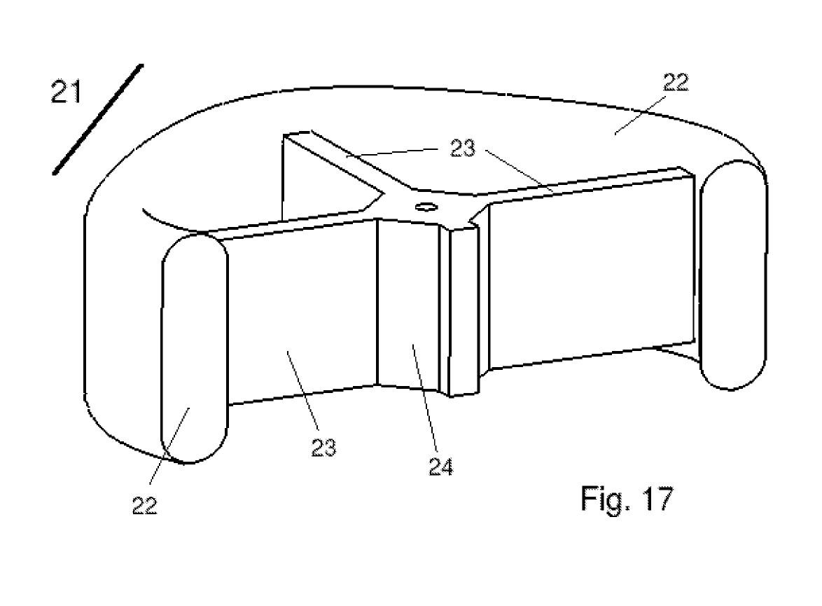

FIGS. 16 and 17 show an embodiment of the standard sub-circular bare filament flywheel rotor 5 where in the filament hoop 22 takes on a more cylindrical form as opposed to the approximately toroidal form of previous inventions. Like the standard sub-circular bare filament flywheel rotor 5, in this cylindrical embodiment 21 the main hoop 22 is made up of flexible fibers, cords, or lines which are able to move with respect to one another to some degree. The hoop 22 is bound to the hub 24 by rigid members 23. The hoop 22 defines an interior diameter that is smaller than the outer diameter defined by the rigid members 23. When spun about the hub 24 axis centripetal forces work on the hoop 22 to establish a more or less perfectly circular form. Because the rigid members 23 define a radius larger than the hoop's 22 ideal circle, the hoop 22 creates a compressive pressure on the rigid members 23 and the hoop is forced to assume a shape that is referred to as “sub circular”. This sub circular arrangement allows the flexible hoop 22 to be tightly linked with the hub 24 while while spinning still allowing the fibers in hoop 22 to remain largely independent of on another. The primary difference between the standard sub-circular embodiment 5 and the cylindrical sub-circular embodiment 21 is that the hoop 22 is such that the vertical cross-sectional dimension of the hoop 22 is longer than the horizontal cross section defining a hoop 22 that more closely resembles a cylinder than a toroid. This configuration is useful in applications where the energy storage capability of the flywheel system is to be optimized for a given foot print.

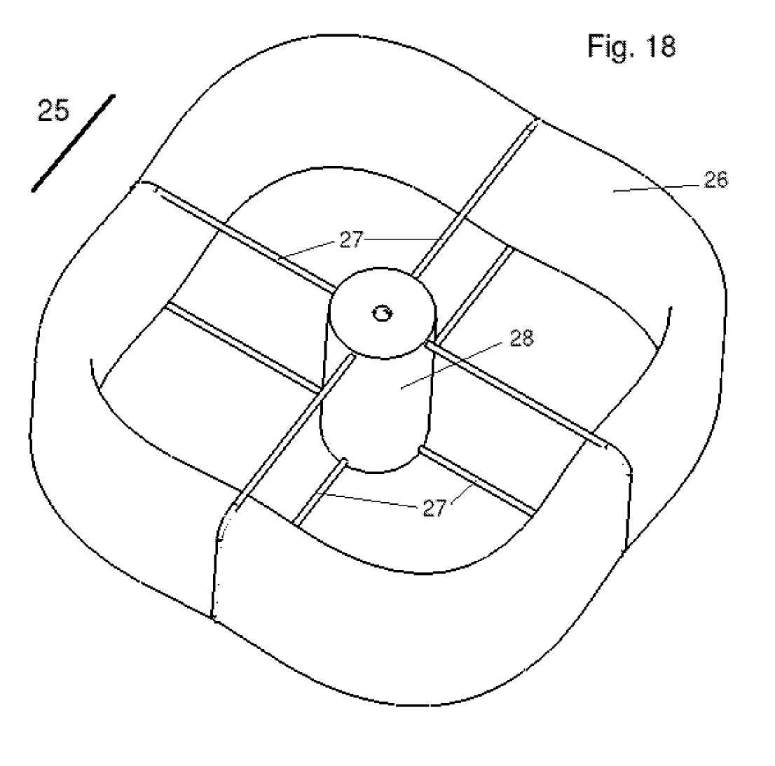

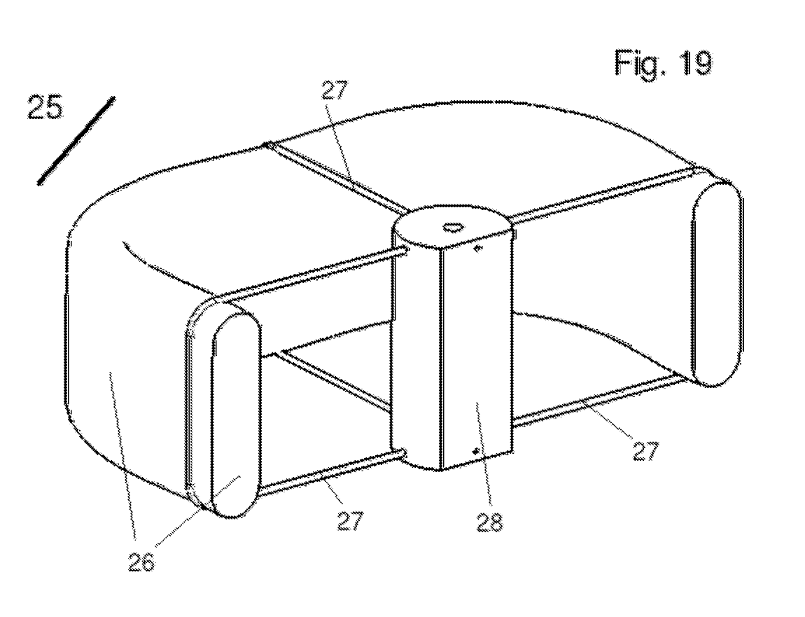

FIGS. 18 and 19 show an embodiment of the super-circular bare filament flywheel rotor 25 where in the filament hoop 26 takes on a more cylindrical form as opposed to the approximately toroidal form of previous invention. Like the standard super-circular bare filament flywheel rotor 16, in this cylindrical embodiment 25 the main hoop 26 is made up of flexible fibers, cords, or lines which are able to move with respect to one another to some degree. The hoop 26 is held to a hub 28 by tensile stringers 27 that define a radius slightly smaller than the hoop 26. Because these stringers define a radius that is smaller than the hoop's 26 ideal circle, when the system 25 is spun about the axis of the hub 28, the hoop exerts a tensile force on the stingers as it tries to assume its ideal circle. The stringers 27 do not allow the hoop 26 to assume this ideal circle, but rather force it to assume a “super-circular” form. In this way, when spun, the hoop becomes linked with the hub 28 while still allowing the filaments of the hoop to remain largely independent of on another. The primary difference between the standard super-circular embodiment 16 and the cylindrical super-circular embodiment 25 is that the hoop 26 is such that the vertical cross-sectional dimension of the hoop 26 is longer than the horizontal cross section defining a hoop 26 that more closely resembles a cylinder than a toroid. This configuration is useful in applications where the energy storage capability of the flywheel system is to be optimized for a given foot print.

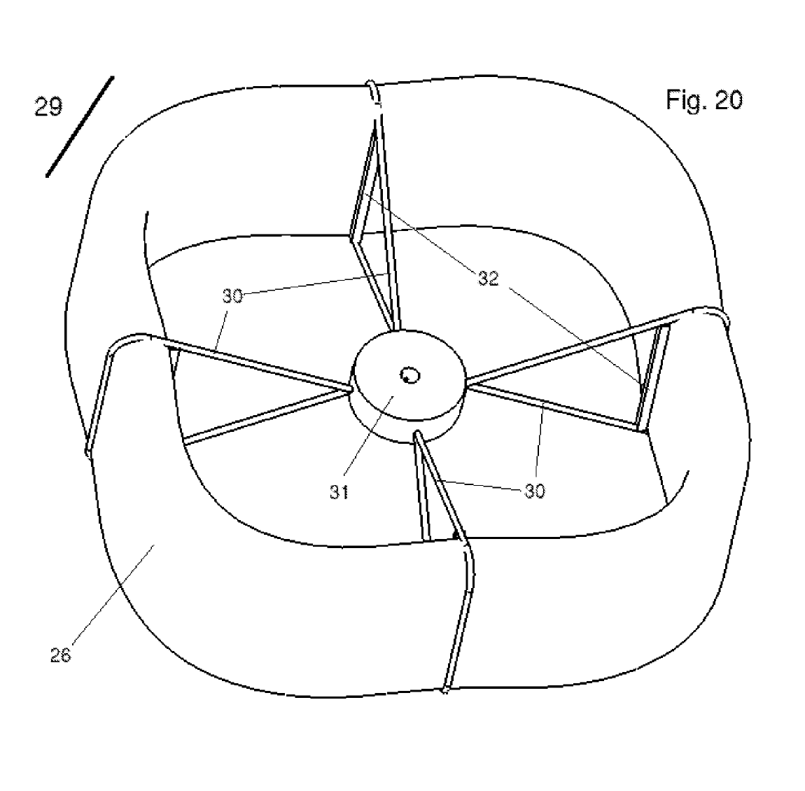

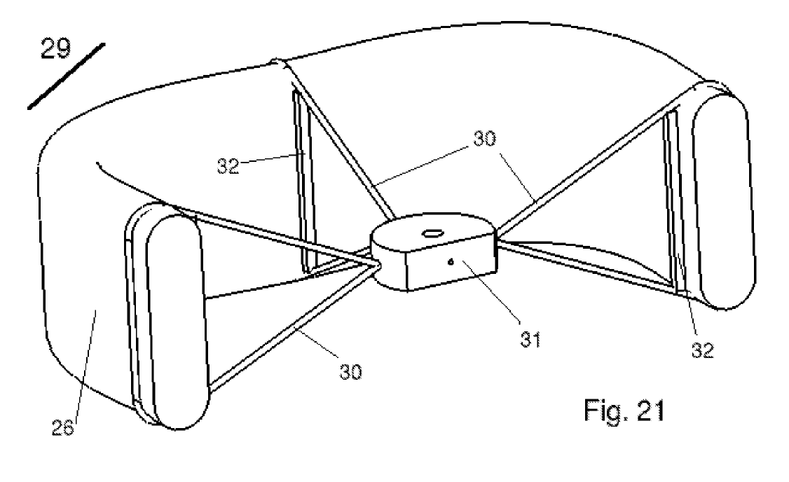

FIGS. 20 and 21 show an embodiment of the super-circular bare filament flywheel rotor 29 where in the filament hoop 26 takes on a more cylindrical form as opposed to the approximately toroidal form of previous invention. Like the standard super-circular bare filament flywheel rotor 16, in this cylindrical embodiment 29 the main hoop 26 is made up of flexible fibers, cords, or lines which are able to move with respect to one another to some degree. The hoop 26 is held to a hub 31 by tensile stringers 30 that define a radius slightly smaller than the hoop 26. These stringers are spread by rigid members 32 to accommodate the height of the hoop 26 and then come back to a central location on the hub 31. Because these stringers define a radius that is smaller than the hoop's 26 ideal circle, when the system 29 is spun about the axis of the hub 31, the hoop exerts a tensile force on the stingers as it tries to assume its ideal circle. The stringers 30 do not allow the hoop 26 to assume this ideal circle, but rather force it to assume a “super-circular” form. In this way, when spun, the hoop becomes linked with the hub 31 while still allowing the filaments of the hoop to remain largely independent of on another. The primary difference between the standard super-circular embodiment 16 and the cylindrical super-circular embodiment 29 is that the hoop 26 is such that the vertical cross-sectional dimension of the hoop 26 is longer than the horizontal cross section defining a hoop 26 that more closely resembles a cylinder than a toroid. This configuration 29 also allows for the use of a smaller hub 31 through the incorporation of rigid vertical members or spreaders 32. This configuration is useful in applications where the energy storage capability of the flywheel system is to be optimized for a given foot print.

1. A flywheel system comprising a motor/generator suspended in a damped gimbal, a flexible coupling attaching the shaft of the motor/generator to a rigid shaft, the rigid shaft attached to a flywheel rotor.

2. The system of claim 1 where the flexible coupling is a universal joint

3. The system of claim 1 where the flywheel rotor is a sub-circular bare filament rotor.

4. The system of claim 1 where the flywheel rotor is a super circular bare filament rotor.

5. The system of claim 1 where the damped gimbal is movable on a singular axis

6. The system of claim 1 where the damped gimbal is movable on more than one axis.

7. The system of claim 1 where the damped gimbal is movable on more than one axis and at least two of those axes are not on the same plane.

8. A flywheel system comprising a motor/generator suspended in a damped gimbal, a flexible coupling attaching the shaft of the motor/generator to a rigid shaft, the rigid shaft attached to a second flexible coupling, the second flexible coupling attached to a flywheel rotor.

9. The system of claim 8 where one of more of the flexible couplings is a universal joint.

10. The system of claim 8 where the flywheel rotor is a sub-circular bare filament rotor.

11. The system of claim 8 where the flywheel rotor is a super circular bare filament rotor.

12. The system of claim 8 where the damped gimbal is movable on a singular axis.

13. The system of claim 8 where the damped gimbal is movable on more than one axis.

14. The system of claim 8 where the damped gimbal is movable on more than one axis and at least two of those axes are not on the same plane.

15. A flywheel system comprising a motor/generator suspended in a damped gimbal, a flexible coupling attaching the shaft of the motor/generator to a rigid shaft, the rigid shaft attached to a second flexible coupling, the second flexible coupling attached to 1, 2, 3, 4, 5, 6, or any arbitrary number of rigid shaft/flexible coupling pairs, this chain of flexible couplings and rigid shafts terminating in an attachment to a flywheel rotor.

16. The system of claim 15 where one or more of the flexible couplings are universal joints.

17. The system of claim 15 where the flywheel rotor is a sub-circular bare filament flywheel rotor.

18. The system of claim 15 where the flywheel rotor is a super-circular bare filament flywheel rotor.

19. The system of claim 15 where the damped gimbal is movable on a singular axis.

20. The system of claim 15 where the damped gimbal is movable on more than one axis.

21. The system of claim 15 where the damped gimbal is movable on more than one axis and at least two of those axes are not on the same plane.

22. The system of claim 15 where the flexible couplings are connected rigidly to one another in a way that approximates a rigid shaft but is exclusive of a separate shaft component for some or all of its length.

23. A flywheel rotor system comprising an approximately cylindrical flywheel rotor having an outer
radius, the flywheel rotor positioned around and bound to a hub by tensile stringers, the stringers each defining a radius smaller than the outer radius of the flywheel rotor, the flywheel rotor having a mass, substantially all of the mass of the rotor comprising fibers, the fibers movable relative to each other in whole or in large part.

24. The system of claim 23 wherein the system also incorporates rigid vertical members for the purpose of directing the tensile stringers so as to maintain the cylindrical form of the hoop, or for some other purpose.

24. The system of claim 23 wherein the fibers are polyolefin.

25. A flywheel rotor system comprising an approximately cylindrical flywheel rotor having an outer radius, the flywheel rotor positioned around and bound to a hub by compressive members, the compressive members each defining a radius larger than the outer radius of the flywheel rotor, the flywheel rotor having a mass, substantially all of the mass of the rotor comprising fibers, the fibers movable relative to each other in whole or in large part.
